(19) United States
(12) Patent Application Publication
(10) Pub. No.: US 2010/0288442 A1
(43) Pub. Date: Nov. 18, 2010

(54) PRESS FOR LAMINATING ESSENTIALLY PLANAR WORK PIECES

(75) Inventor: Norbert Damm, Karlsdorf-Neuthard (DE)

Correspondence Address: VOLPE AND KOENIG, P.C., UNITED PLAZA, 30 SOUTH 17TH STREET, PHILADELPHIA, PA, 19103, US

(73) Assignee: Robert Burkle GmbH, Freudenstadt (DE)

(21) Appl. No.: 12/778,482

(22) Filed: May 12, 2010

(30) Foreign Application Priority Data
May 12, 2009 (DE) 10 2009 020 991.3

(51) Int. Cl. B32B 37/00; B29C 65/02

(52) U.S. Cl. 156/382; 156/580

(57) ABSTRACT

A press for laminating essentially planar work pieces under the effects of pressure and heat is provided, having a bottom half of the press and a top half of the press, which are movable in reference to each other in order to open and close the press, with the bottom half of the press and the top half of the press, in the closed state, together with circumferential seals forming a vacuum chamber. A pliable diaphragm divides the vacuum chamber into a product space that can be evacuated and is provided to receive at least one work piece, and a pressure space that can be evacuated and/or impinged with pressure. The diaphragm is embodied and arranged such that due to the pressure difference in the vacuum chamber, created by evacuating the product space and/or by impinging it with pressure, the work piece is pressed directly or indirectly against the bottom of the vacuum chamber 14. The pliable diaphragm is a web or a film with gas-tight and pliable features, that is generally non-expandable over its entire area and thus quasi inelastic. Further it is coated with a low-friction material and/or comprises such a material.

### CROSS-REFERENCE TO RELATED APPLICATIONS

This application claims the benefit of German Patent Application No. 10 2009 020 991.3, filed May 12, 2009, which is incorporated herein by reference as if fully set forth.

### BACKGROUND

The invention relates to a press for laminating essentially planar work pieces under the effects of pressure and heat, as well as a pliable diaphragm for such a press.

Accordingly, a press of the above-mentioned type comprises a bottom half of the press and a top half of the press, which are movable in reference to each other in order to open and close the press. In the closed state, the bottom half of the press and the top half of the press form a vacuum chamber via circumferential seals comprising one or more parts, inside which one or more work pieces are laminated. A pliable diaphragm divides the vacuum chamber into a product space that can be evacuated and is provided to accept at least one work piece and a pressure space that can be evacuated and/or pressurized. Due to the difference in pressure inside the vacuum chamber created by evacuating the product space and/or by pressurizing the pressure space the diaphragm is pressed against the work piece, causing it to directly or indirectly press the work piece against a bottom of the vacuum chamber and thus applying the load upon the work piece necessary for lamination. In general, the bottom of the vacuum chamber is formed by a heating plate such that the processing heat required for lamination is directly introduced into the work piece during the molding cycle. However, different ways of introducing said processing heat are also possible.

A press of the present type is preferably used for laminating photo-voltaic modules. They usually comprise a layer of solar cells, arranged with their electric contact elements between a glass pane and a weather-resistant film or between two glass panes and laminated to the glass panes and/or films via one or more adhesive layers and thus being encapsulated in a light-permeable laminar structure in a moisture-proof as well as weather resistant fashion.

In order to laminate a work piece and/or simultaneously several work pieces, for reasons of simplicity in the following only one work piece will be discussed, the work piece is brought into the product space of the vacuum chamber and the vacuum chamber is closed. Then, usually first the pressure space of the vacuum chamber is evacuated in order to pull the diaphragm upwards to the top half of the chamber. Subsequently, usually with a certain time lag, the product space is also evacuated, with the evacuation of both spaces of the vacuum chamber being regulated such that at all times a pressure difference remains between the pressure space and the product space, holding the diaphragm in the top half of the chamber and prevents that the diaphragm prematurely contacts the work piece.

When the product space of the press chamber has been evacuated to a predetermined pressure level, usually amounting to less than 1 mbar, the pressure space is ventilated such that the pressure difference between the pressure space and the product space are inversed and the diaphragm contacts the work piece. By controlling the pressure inside the pressure space then the desired compression of the diaphragm is appropriately adjusted to create the load upon the work piece necessary for lamination.

The processing heat required for the lamination process is usually introduced into the work piece such that the bottom of the vacuum chamber is embodied as a heating plate, with the diaphragm pressing the work piece against it. The pressure and the processing heat then jointly cause the softening and/or activation of the adhesive layer and its curing and/or cross-linking, if applicable.

The rapid evacuation, particularly of the product space of the vacuum chamber, if possible even prior to any considerable heating of the work piece, allows that any potentially trapped air (residual air between the layers of the work piece) or gases potentially formed during the heating process are evacuated from the work piece before any curing and/or cross-linking of the adhesive begins inside the adhesive layer; because gas bubbles in the finished, laminated work piece compromise its life expectancy quite considerably or, in the worst case scenario, lead to the immediate uselessness of the work piece, i.e. to the production of defective products.

The pliable diaphragm used in presses of the present type is usually made from a highly-flexible material with an elasticity and/or ultimate elongation amounting to 500-600%, most frequently made from silicon, or in fewer applications, made from natural rubber. In the primary application, the lamination of photo-voltaic modules, previously, there have not been any alternatives. Since the overwhelming majority of photo-voltaic modules comprise a layer of solar cells, comprising solar cells made from crystalline silicon wafers and usually showing a material thickness of no more than 0.1 to 0.2 mm; accordingly they are very brittle. The design of these photo-voltaic modules in turn usually comprises a laminar structure having a glass substrate, a first EVA-adhesive film, a layer of solar cells, a second EVA-adhesive layer, and a rear film. Due to the brittleness of the crystalline solar cells, experts in the field have predominantly come to believe that the pliable diaphragms to be used for compressing the above-mentioned layers during the lamination process have to comprise a highly elastic and soft material with a shore hardness <50. Here, the highly elastic features are primarily important because the diaphragm is required to compensate for any and all irregularities existing in the modular structure, particularly those between the individual silicon-solar cells and their encapsulation.

Furthermore, a highly elastic material is also necessary for the pliable diaphragm due to the fact that it must be pre-stressed mechanically in order at all times to allow it to be pressed upon the photo-voltaic module without any folds; because during the lamination process particularly photo-voltaic modules of the type mentioned at the outset, i.e. those with a rear film, have a soft rear side during the lamination process, so that the diaphragm may not leave any folds, notches, or impression of any kind during the compression process. However, in order to allow a pre-stressed diaphragm to move perpendicularly in reference to its surface, which is necessary for the lamination process, and thus to be pressed upon the photo-voltaic module, it must show highly elastic characteristics.

Additional requirements for the pliable diaphragm result from its function of gas-tight dividing the vacuum chamber into a pressure space and a product space in a gas-tight fashion. The material of the diaphragm must be gas-tight. Further, the material must be heat resistant up to approximately 180° C.-200° C. due to the heat-controlled lamination process. Finally, a certain chemical resistance against the films and adhesives used in the photo-voltaic module are also required.

All of the above-mentioned features, according to predominant opinion, are required for a pliable diaphragm according to the prior art, are presently best fulfilled by diaphragms made from silicon or natural rubber, foreclosing any real alternatives. However, here it is disadvantageous for the diaphragms made from these materials to be relatively expensive. Additionally, only a life of a few thousand cycles can be yielded, usually. This is primarily caused, in addition to mechanic influences, in the reactants released by the adhesive film most frequently used in photo-voltaic modules, EVA, during the lamination process. In particular peroxide and acetic acid seem to quite considerably affect the diaphragms made from silicon and natural rubber so that their life expectancy is reduced.

### SUMMARY

The present invention is therefore based on the object of providing a pliable diaphragm for a press of the type mentioned at the outset as well as a press provided with such a pliable diaphragm which is cost effective and/or can achieve a longer life.

This object is attained in a press as well as a flexible diaphragm according to the invention.

Preferred embodiments of the press according to the invention are disclosed in detail below along with advantageous embodiments of the pliable diaphragm.

Contrary to prior art, the pliable diaphragm according to the present invention comprises a web or a film which is gas-tight or pliable, but also tensile resistant over its entire area and thus has non-elastic features. The inelastic features of the pliable diaphragm according to the invention preferably result from the selection of the material, having a failure strain of beneficially less than 60%, preferably less than 50%, and particularly preferred less than 15%. The failure strain of the pliable diaphragm according to the invention is therefore lower than the highly-elastic diaphragms of prior art, preferably by more than a factor of 10.

According to the invention it has been learned that the previously mandatory highly-elastic material features of the diaphragm are not required at all to yield good results during the lamination of preferably photo-voltaic modules. The gas-tight features, the temperature resistance, and the flexibility in the sense of the material being pliable without any considerable stretchability of the material itself, are completely sufficient, as learned according to the invention, to yield good results during the lamination process.

Experiments of the applicant have shown that during the ventilation of the pressure space in the closed press the diaphragm adheres at the points of the first contact with the work piece or, if applicable, the intermediate separating film, in an almost non-displaceable fashion due to the good friction-fitting of the rubber-like surface of the previously used silicon or natural rubber, when the pliable diaphragm is lowered onto the work piece in order to apply the load necessary for lamination. Any additional movement of the diaphragm towards the work piece subsequently creates local expansion in the diaphragm, which may lead to considerable elastic stress at the edge of the module to be laminated, thus potentially resulting in a displacement of the individual modular layers in reference to each other as soon as the adhesive layers have been heated above their softening temperature. In particular the solar cells of a photo-voltaic module frequently begin to “float” in the module when the softening temperature of the adhesive layers is exceeded under the load of a highly flexible diaphragm.

The use of an inelastic, pliable diaphragm according to the invention for applying the surface pressure upon the work piece during the lamination process reduces the forces affecting the edge of the work piece because the inelastic, pliable diaphragm contacts the edges of the work piece less easily and automatically than highly-elastic diaphragms do. However, it has surprisingly shown that the lamination results are of equal or even better quality than those using a highly elastic, flexible diaphragm according to prior art, at least when the diaphragm according to the invention is coated with a low-friction material and/or comprises a low-friction material.

Due to the inelastic embodiment of the pliable diaphragm, additionally another disadvantage of the highly-elastic flexible diaphragms of prior art is eliminated. A highly-elastic diaphragm immediately and closely contacts the area of the product space adjacent to the work piece as well as the work piece itself at all sides during ventilation of the pressure chamber. This results in the work piece being sealed in an air-tight fashion such that any potentially remaining residual air, primarily however any gases developing during the lamination (residual moisture, catalyzing gases, gaseous plasticizers, and the like) cannot evacuate from the work piece and cannot be suctioned off. A membrane that is pliable but non-elastic or quasi inelastic, as suggested in the present invention, shows no such effect or shows it only to a considerably lesser extent. Due to its poor elasticity the pliable diaphragm according to the present invention contacts the edges of the work piece at all sides less tightly and primarily not as quickly.

The pliable diaphragm according to the present invention may comprise plastic and/or metal; preferably it is made from a tightly formed cloth material comprising industrial fibers. Such industrial fibers preferably comprise aramid, fiberglass, PTFE, PC, or the like; alternatively they may also be formed from metal fibers or plastic-coated metal fibers. A blend of these materials is also possible. These embodiments of a pliable diaphragm embodied according to the invention is much more cost effective than the previously used silicon or natural rubber diaphragms, with a simultaneously much longer life expectancy, because the respectively suggested materials are considerably less sensitive to reactants discharged from the adhesive films.

The pliable diaphragm according to the present invention may show a material thickness of <approximately 1 mm, preferably ranging from approximately 0.25 to approximately 5 mm. This is of positive influence on the advantageously lower costs of the suggested diaphragm as well as the pliable material features still required.

It is particularly preferred that the pliable diaphragm suggested within the scope of the present invention is coated with PTFE, at least at its side facing the work piece, while the side facing away from the work piece comprises a coating with a rubber-like, gas impermeable layer, for example, in order to create a gas-tight feature. The latter is particularly useful if the pliable diaphragm represents a material web.

The coating of the diaphragm with PTFE ensures that the diaphragm is no longer negatively influenced by the reactants discharged by the adhesive films and additionally allows that the friction between the pliable diaphragm and the work piece and/or a separating film is reduced by a multiple in reference to prior art such that any mutual gliding during ventilation of the pressure chamber is possible at any time and no damage to the work piece needs to be feared by the pliable diaphragm adhering thereto.

Additional advantages result when the pliable diaphragm is mounted in the press sagging loosely such that, when the press is closed and the pressure is evened out in the product space and the pressure space, it at least partially contacts the work piece, i.e. sags down to it. This allows the diaphragm, in spite of its inelastic features, to still be pulled upwards by an appropriately selected pressure difference during the evacuation of the vacuum chamber, away from the work piece, between the pressure space and the product space like in prior art, while it can travel the distance to the work piece during the ventilation of the pressure space in order to apply the load upon the work piece due to the increasing pressure different between the pressure space and the processing space.

Beneficially, for this purpose the pliable diaphragm is mounted between a top half and a bottom half of the two-part frame of the diaphragm, with the frame of the diaphragm being mounted to the upper half of the press. This automatically results in a distance between the level in which the diaphragm is mounted and the surface of the work piece, which is required for feeding the press.

As mentioned above, highly elastic, pliable diaphragms according to prior art must be pre-stressed before they contact the work piece by ventilating the pressure space. This is important to avoid any formation of folds on the work piece. The tensile elements, required at the diaphragm fastener of the presses according to prior art, are relatively complicated, though, and thus accordingly quite costly.

Due to the fact that the pliable diaphragm suggested according to the invention is essentially inelastic and preferably coated with PTFE or a similarly low-friction material at the side facing the work piece or if applicable is made from such a material partially or in its entirety, the formation of any folds is not to be expected when the diaphragm loosely contacts the work piece in the initial state and/or sags down to it. Any folds potentially developing in spite of the low elasticity of the diaphragm are then smoothened during the suction process by way of evacuating the product space and/or by ventilation the pressure space.

By using a diaphragm that is pliable but quasi inelastic as suggested according to the invention, not only cost-savings can be achieved by the low procurement costs of the diaphragm itself, but also the omission of stress elements, the time-consuming stressing processes, and the considerably higher life expectancy of the diaphragm can be obtained. Additionally, even better results in the lamination of particularly photo-voltaic modules results. Further, the pliable diaphragms now can be “custom made” according to the features required, particularly by selecting materials for the diaphragm web, for example plastic, metal, or fiberglass.

### BRIEF DESCRIPTION OF THE DRAWINGS

In the following, an exemplary embodiment for a press embodied according to the invention is described and explained in greater detail using the attached drawings. Shown are:

FIG. 1 is a schematic cross-sectional view of a press embodied according to the invention, taken in a direction perpendicular in reference to the direction of travel, in the open state;

FIG. 2 is a view according to FIG. 1, however in the closed state; and

FIG. 3 is a view according to FIG. 1, however during the actual lamination process.

### DETAILED DESCRIPTION OF THE PREFERRED EMBODIMENTS

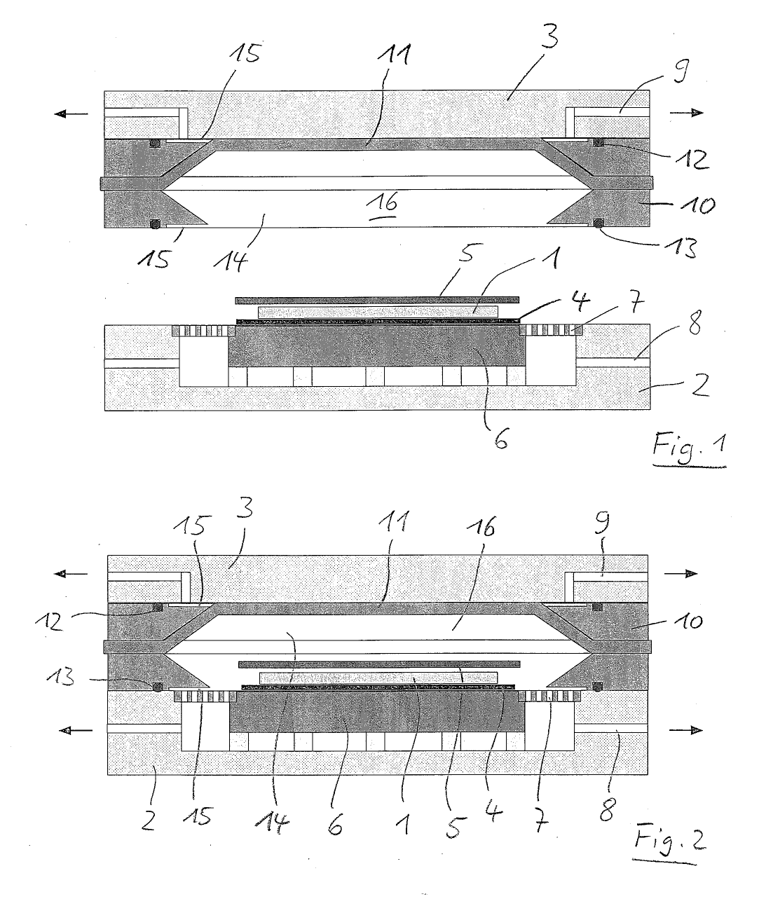

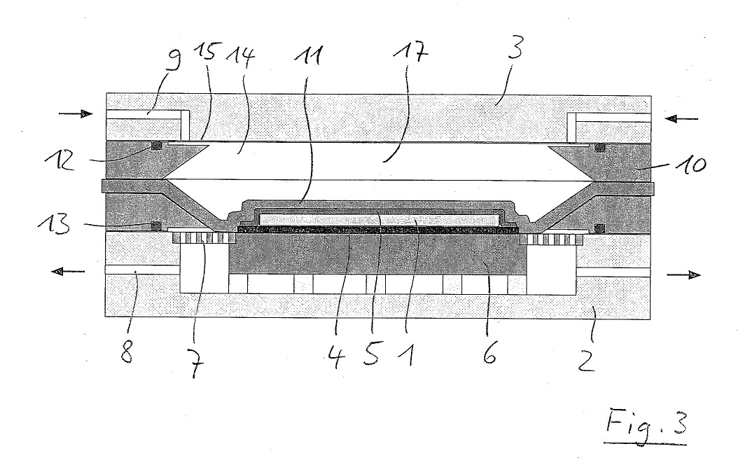

FIGS. 1, 2, and 3 show schematically an illustration in cross-section through a press embodied according to the invention for laminating a photo-voltaic module 1, with the direction of travel of the photo-voltaic module 1 being perpendicular in reference to the drawing plane, and with FIG. 1 showing an open press during coating, FIG. 2 a closed press during evacuation, and FIG. 3 a closed press during the actual lamination process.

In the press, formed from a bottom press half 2 and a top press half 3, a photo-voltaic module 1 is arranged between a conveyer belt 4 and a separating film 5. The conveyer belt 4 is supported on the bottom press half 2, comprising in this area a heating plate 6 in order to introduce the necessary processing heat to the photo-voltaic module 1. Seen in the travel direction, laterally next to the heating plate 6, several evacuation openings 7 are located in the bottom press half 2, which open in the lower channels 8. The lower channels 8 are here connected to evacuation and ventilation means (not shown.) The conveyer belt 4 serves to insert the photo-voltaic module 1 into the press and to transport it out of it such that it passes through the press perpendicularly in reference to the plane of the drawing.

The top half of the press 3 is provided with upper channels 9 for evacuating, ventilating, or impinging with pressure, and it carries a double frame 10, in which a diaphragm 11 is clamped. Together with the circumferential upper seal 12 and the lower seal 13, each sealing the top half of the press 3 and the bottom half of the press 2, respectively, the double frame 10 forms a multi-part seal for a gas-tight closure of the press, with it defining a vacuum chamber 14 in its interior, together with the adjacent halves 2, 3 of the press. The vacuum chamber 14 is connected to the lower and the upper channels 8, 9 via recesses 15. Here, the diaphragm 11 divides the vacuum chamber 14 in a gas-tight fashion into a product space 16 located underneath the diaphragm and connected to the lower channels 8, and a pressure space 17 located above the diaphragm 11 and connected to the upper channels 9.

FIG. 1 shows the phase in which the photo-voltaic module 1 on the conveyer belt 4 together with the separating film 5 resting thereupon has been inserted into the press in the area of the vacuum chamber 14; here the press is still open. In order to protect the diaphragm 11 from mechanical damages it is suctioned into the top half of the press 3 via the upper channels 9.

By lowering the top half of the press 3 the press is then closed, as shown in FIG. 2. The vacuum chamber 14 is evacuated via the upper channels 9 and the lower channels 8; however, it must be ensured that the pressure above the diaphragm 11 is lower than the one underneath the diaphragm 11, i.e. the diaphragm 11 remains suctioned upward towards the top half of the press 3. Accordingly, in FIG. 2 only the product space 16 is visible, however not the pressure space 17.

After the product space 16 has been evacuated to a final pressure of approximately 1 mbar the pressure space 17 is ventilated via the upper channels 9 such that a situation results as shown in FIG. 3. The diaphragm 11 contacts the photo-voltaic module 1, due to the existing difference in pressure, and presses it against the heating plate 6. Here, the separating film 5 prevents any direct contact of the diaphragm 11 to the photo-voltaic module 1 such that any discharged adhesive cannot reach the diaphragm 11. The phase shown in FIG. 3 is the actual lamination phase, in which the photo-voltaic module 1 is compressed via the diaphragm 1 while it is impinged with heat from the heating plate 6 via the conveyer belt 4.

Contrary to prior art, the pliable diaphragm 11 of this exemplary embodiment is not a highly-elastic diaphragm, made from silicon or natural rubber, but a diaphragm, over its entire diaphragm area only pliable, i.e. bendable, but quasi inelastic, because it is made from a generally non-stretchable aramid web with a low-friction coating of PTFE at the side facing the product and a rear coating of a gas-impermeable, rubber-like layer. The separating film 5 is also coated with PTFE, so that during the lamination process (FIG. 3) in the laminar structure of the diaphragm 11, the separating film 5, and the photo-voltaic module 1 very low-friction surfaces contact each other, safely preventing any formation of folds. Thus, there is no longer any threat of deformations in the photo-voltaic module 1. The evacuation of the immediate volume of the photo-voltaic module 1 is improved by the evacuation openings 7.

As discernible from FIGS. 1 and 2, the diaphragm 11 is not stressed in the double frame 11 as in prior art, rather it is only loosely fastened, here. This way, in spite of the lack of elasticity of the diaphragm 11, it is possible to pull it upward against the top half of the press 3, during the feeding (FIG. 1) as well as during the evacuation (FIG. 2), by applying a vacuum via the upper channels 9, and to hold it there until the pressure space 17 is once more ventilated via the upper channels 9. The status of the pliable diaphragm 11 shown in FIG. 3 is also permitted in it being held loosely in the double frame 10. The fact that any expansion of the diaphragm 11 according to the invention is possible within tight limits only, which on the other hand, as described above in detail, has advantages in the edge regions of the photo-voltaic module 1, because here the diaphragm 11 contacts less easily than the highly elastic diaphragm according to prior art.

The above-described embodiment of the pliable diaphragm 11 according to the present exemplary embodiment ensures high chemical resistance against emitted reactants as well as a very high mechanic stability so that the life expectancy of this diaphragm 11 is considerably increased in reference to prior art. Simultaneously, its production is relatively simple, which offers cost benefits. Finally, it is much easier to insert the diaphragm 11 according to the invention loosely into the double frame 10 than to stretch a highly elastic diaphragm according to prior art in the double frame 10, as well as to preheat it, perhaps, and then to readjust it before the actual lamination process begins.

1. A press for laminating essentially planar work pieces under the effect of pressure and heat, comprising a bottom half of the press (2) and a top half of the press (3), which are movable in reference to each other in order to open and close the press, with the bottom half of the press (2) and the top half of the press (3) in a closed state forming a vacuum chamber (14) via circumferential seals (12, 13), produced in one or more pieces, and a pliable diaphragm (11) divides the vacuum chamber (14) into a product space (16) that can be evacuated and is provided for receiving at least one work piece (1) and a pressure space (17) that can be evacuated and/or can be impinged with pressure, the diaphragm (11) is embodied and arranged such that due to a pressure difference in the vacuum chamber (14) created by at least one of evacuating the product space (16) or by impinging the pressure space (17) with pressure, it directly or indirectly presses the work piece (1) against the bottom (2) of the vacuum chamber (14), the pliable diaphragm (11) comprises a web or a film having a gas-tight, pliable, and generally, over an entire surface, non-expandable and thus quasi inelastic property, and the pliable diaphragm (11) is at least one of coated with a low-friction material or comprises such a material.

2. A press according to claim 1, wherein the pliable diaphragm (11) is made from at least one of plastic or metal.

3. A press according to claim 1, wherein the pliable diaphragm (11) comprises a tightly woven cloth made from industrial fibers.

4. A press according to claim 3, wherein the industrial fibers comprise at least one of aramid, fiberglass, PTFE, PC, metal fibers or plastic-coated metal fibers.

5. A press according to claim 1, wherein the pliable diaphragm (11) is coated at least at its side facing the work piece (1) with PTFE.

6. A press according to claim 1, wherein the pliable diaphragm (11) has a material thickness of less than approximately 1 mm.

7. A press according to claim 1, wherein the pliable diaphragm (11) comprises a material with a failure strain amounting to less than 60%.

8. A press according to claim 1, wherein the pliable diaphragm (11) is fastened in the press loosely sagging such that it contacts, at least partially, the work piece (1) when the press is closed and a pressure in the product space (16) and the pressure space (17) is equal.

9. A press according to claim 8, wherein the pliable diaphragm (11) is fastened between a top half and a bottom half of a two-part diaphragm frame (10), with the diaphragm frame (10) being mounted to the top half of the press (3).

10. A pliable diaphragm to be inserted into a press, comprising a web or a film having gas tight and pliable as well as non-expandable and thus quasi inelastic property over an entire area, and at least one of a low-friction material is located on the web or film or the web or film comprises a low-friction material.

11. A pliable diaphragm according to claim 10, wherein the web or film comprises a material having a failure strain amounting to less than 60%.

12. A pliable diaphragm according to claim 10, wherein the web or film includes a gas-tight coating.
